(19) United States
(12) Patent Application Publication
(10) Pub. No.: US 2026/0121527 A1
(43) Pub. Date: Apr. 30, 2026

(54) POWER CONVERSION DEVICE

(71) Applicant: MetaPWR Electronics Co., Ltd., Shanghai (CN)

(72) Inventors: Da Jin, Shanghai (CN); Yahong Xiong, Shanghai (CN)

(73) Assignee: MetaPWR Electronics Co., Ltd., Shanghai (CN)

(21) Appl. No.: 19/370,759

(22) Filed: Oct. 28, 2025

(30) Foreign Application Priority Data
Oct. 29, 2024 (CN) 202411522936.0

(51) Int. Cl. H02M 3/00; H02M 1/00; H02M 1/088; H02M 3/335

(52) U.S. Cl. CPC H02M 3/003; H02M 1/0054; H02M 1/088; H02M 3/33569

(57) ABSTRACT

The present application is directed to a power conversion device, which further reduces the thickness and volume of the power conversion device by optimizing the layout structure and winding method of the power conversion device. On the other hand, by optimizing the control/driving mode, the four control signals are used to realize low-loss driving control of the plurality of switches.

### CROSS-REFERENCE TO RELATED APPLICATION

This application claims the priority benefit of China application serial no. CN202411522936.0 filed on October 29, 2024. The entirety of the above-mentioned patent application is hereby incorporated by reference herein and made a part of this specification.

### BACKGROUND

### Description of Related Art

With the development of artificial intelligence, the power requirements of intelligent data processing chips, such as GPU/CPU/NPU, etc. (collectively, xPU) are increasingly high, so that the power of the server is increased, the input voltage of the server gradually changes from 12V to 48V. The operating voltage of the xPU is increasingly low as the process progresses, and gradually moves from 0.8V to 0.65V. Therefore, the ratio of the input voltage to the output voltage becomes larger and larger, so that the two-stage buck circuit architecture gradually becomes the mainstream; the two-stage buck circuit architecture comprises a front-stage proportional converter and a rear-stage voltage regulator.

The present application provides a power conversion circuit, which is used for converting a 48V input voltage into a pre-stage ratio converter of an intermediate bus voltage. By optimizing the winding manner of the transformer winding and the layout of the power device, and by means of the low-loss driving circuit, the low-loss and small-volume characteristics of the front-stage proportional converter are realized.

### SUMMARY

In view of the above, one of the objectives of the application is to provide a power conversion device, comprising:

a substrate, a magnetic core assembly, a winding, a first sub-circuit, and a second sub-circuit, wherein the first sub-circuit comprises four first lower switches, and the second sub-circuit comprises four second lower switches;

the magnetic core assembly comprises an upper magnetic cover, a lower magnetic cover, and four magnetic columns, the four magnetic columns are arranged between the upper magnetic cover and the lower magnetic cover, and the four magnetic columns are arranged in a manner of 2×2;

the substrate comprises an upper surface and a lower surface opposite to each other, and four hole-grooves, the hole-grooves passing through the upper surface and the lower surface, and each of the hole-grooves allowing one of the four magnetic columns to pass through; the upper magnetic cover and the lower magnetic cover respectively assembled the substrate from the upper surface and the lower surface; a winding is provided between the four hole-grooves;

the magnetic core assembly further comprises a first side and a second side opposite to each other; a lower switch set is provided along both the first side and the second side, and the lower switch set comprises a first lower switch, a second lower switch, a second lower switch, and a first lower switch arranged in sequence; a first end and a second end of the winding are arranged adjacent to the first side and/or the second side.

Preferably, the first sub-circuit further comprises a first upper switch and a first middle switch; the second sub-circuit further comprises a second upper switch and a second middle switch;

the power conversion device further comprises an input positive terminal, an input negative terminal, an output positive terminal and an output negative terminal;

a drain electrode of each of the upper switches is electrically connected to the input positive terminal, a source electrode of the first upper switch and a drain electrode of the first intermediate switch are connected to a first upper node, and a source electrode of the second upper switch and a drain electrode of the second middle switch are electrically connected to a second upper node;

the first lower switch is connected between a first lower node and the output negative terminal, and the second lower switch is connected between a second lower node and the output negative terminal; the first upper switch, the second upper switch, the first middle switch, and the second middle switch are all disposed on the first side of the magnetic core assembly and are all disposed adjacent to the lower switch set; a source of the first middle switch is electrically connected to the first lower node or the input negative terminal, and a source of the second middle switch is electrically connected to the second lower node or the input negative terminal.

Preferably, the power conversion device, further comprising an output capacitor, wherein the output capacitor is respectively disposed on the first side and the second side of the magnetic core assembly, and the output capacitor is disposed adjacent to the lower switch group; and the output capacitor disposed on the lower surface at least partially overlaps with a projection of the lower switch set disposed on the upper surface on the same horizontal plane.

Preferably, the power conversion device, further comprising an input capacitor, wherein the input capacitor is arranged on the lower surface of the substrate, the first upper switch, the second upper switch, the first middle switch and the second middle switch are arranged on the upper surface of the substrate, and projections of the input capacitor and at least one switch of the first upper switch, the second upper switch, the first middle switch and the second middle switch on the same horizontal plane at least partially overlap.

Preferably, the winding comprises a high-voltage winding, a first low-voltage winding, and a second low-voltage winding;

the power conversion device further comprises a resonant capacitor, wherein the resonant capacitor and the high-voltage winding are connected in series and then connected between the first upper node and the second upper node; a first end of the first low-voltage winding and a first end of the second low-voltage winding are electrically connected to a first lower node and a second lower node, respectively; a second end of the first low-voltage winding and a second end of the second low-voltage winding are connected with the output positive terminal.

Preferably, the resonant capacitor is disposed on the lower surface of the substrate, and the resonant capacitor is disposed adjacent to the first upper switch and the second upper switch.

Preferably, the power conversion device, further comprising two sets of output electrical connectors, wherein each set of the output electrical connectors is disposed on the first side and the second side of the magnetic core assembly, respectively.

Preferably, the four hole-grooves comprise a first hole-groove, a second hole-groove, a third hole-groove, and a fourth hole-groove; wherein the first hole-groove, the second hole-groove, the third hole-groove, and the fourth hole-groove are sequentially arranged in the same direction;

a first end and a second end of the high-voltage winding are both disposed adjacent to the first side of the magnetic core assembly, and the substrate is a multi-layer printed circuit board; from the first end to the second end of the high-voltage winding, first, wound half circle around the first hole-groove in a clockwise direction in a first layer, then, reached a second layer by means of a second via hole; second, wound one circle around the first hole-groove in clockwise direction, then wound one circle around the fourth hole-groove in counterclockwise direction, then reached the first layer by means of a fourth via hole; third, wound one circle around the fourth hole-groove in clockwise direction, then wound one circle around the third hole-groove in clockwise direction, then reached the second layer by means of a third via hole; fourth, wound one circle around the third hole-groove in clockwise direction, then wound one circle around the second hole-groove in counterclockwise, then reached the first layer by means of a first via hole; finally, wound one circle around the second hole-groove in counterclockwise, then wound half circle around the second hole-groove in clockwise direction, and go back to the second end.

Preferably, each of the low-voltage windings comprises four sub-windings, and each of the sub-windings is wound around one hole-groove; each of the low-voltage windings has opposite winding directions on any two adjacent hole-grooves; at the first side and the second side of the magnetic core assembly, the second end of the first low-voltage winding is disposed between the two first ends, and the first end of the second low-voltage winding is disposed between the two second ends.

A power conversion device, comprising:

a first sub-circuit, a second sub-circuit, four control signals, a timing control/driving circuit, and a low-loss driving circuit;

the first sub-circuit comprises a first upper switch, a first middle switch, and a first lower switch, and the second sub-circuit comprises a second upper switch, a second middle switch and a second lower switch;

the four control signals generate two upper driving signals, two intermediate driving signals, a first intermediate signal, a second intermediate signal, a third intermediate signal, and a fourth intermediate signal by means of the timing control/drive circuit; the two upper driving signals are respectively used for controlling the turn-on and turn-off of the first upper switch and the second upper switch, and the two intermediate driving signals are respectively used for controlling the turn-on and turn-off of the first middle switch and the second middle switch;

the first intermediate signal, the second intermediate signal, the third intermediate signal, and the fourth intermediate signal generate two lower driving signals via the low-loss driving circuit, and the two lower driving signals are respectively used to control the turn-on and turn-off of the first lower switch and the second lower switch;

the four control signals are a first control signal, a second control signal, a third control signal, and a fourth control signal.

Preferably, the first intermediate signal and the second intermediate signal are generated by the third control signal, and the third intermediate signal and the fourth intermediate signal are generated by the fourth control signal.

Preferably, a rising edge of the first intermediate signal is consistent with a rising edge of the third control signal, and a falling edge of the first intermediate signal is delayed from a falling edge of the third control signal; the rising edge of the second intermediate signal is delayed from the rising edge of the third control signal, and the falling edge of the second intermediate signal is consistent with the falling edge of the third control signal; the rising edge of the third intermediate signal is consistent with the rising edge of the fourth control signal, and the falling edge of the third intermediate signal is delayed from the falling edge of the fourth control signal; the rising edge of the fourth intermediate signal is delayed from the rising edge of the fourth control signal, and the falling edge of the fourth intermediate signal is consistent with the falling edge of the fourth control signal.

Preferably, the low-loss driving circuit comprises an auxiliary positive terminal, an auxiliary negative terminal, a driving inductor, a first driving bridge arm, and a second driving bridge arm;

the first driving bridge arm and the second driving bridge arm are both connected between the auxiliary positive terminal and the auxiliary negative terminal; the first driving bridge arm comprises a first upper driving switch and a first lower driving switch, and the first upper driving switch and the first lower driving switch are electrically connected in series to the second driving point; the second driving bridge arm comprises a second upper driving switch and a second lower driving switch, and the second upper driving switch and the second lower driving switch are electrically connected in series to the first driving point;

the driving inductor is connected between the first driving point and the second driving point; the auxiliary negative terminal is electrically connected to the output negative terminal;

the first intermediate signal is used for controlling the turn-on and turn-off of the first upper driving switch, the second intermediate signal is used for controlling the turn-on and turn-off of the first lower driving switch, the third intermediate signal is used for controlling the turn-on and turn-off of the second upper driving switch, and the fourth intermediate signal is used for controlling the turn-on and turn-off of the second lower driving switch.

Preferably, the first driving point is electrically connected to a gate electrode of the first lower switch and is used for driving the first lower switch to be turned on and turned off; the second driving point is electrically connected to a gate electrode of the second lower switch and is used for driving the turn-on and turn-off of the second lower switch;

a switching period of the power conversion device comprises a first interval, a second interval, a first dead time and a second dead time; in the first interval, the first driving point is at a high potential relative to the output negative terminal, and the second driving point is a low potential relative to the output negative terminal; in the second interval, the second driving point is at a high potential relative to the output negative terminal, and the first driving point is at a low potential relative to the output negative terminal; in the first dead time, a voltage of the first driving point relative to the output negative terminal is reduced from a high potential to a low potential, and a voltage of the second driving point relative to the output negative is changed from a low potential to a high potential; and in the second dead time, a voltage of the second driving point relative to the output negative terminal is reduced from a high potential to a low potential, and a voltage of the first driving point relative to the output negative terminal is changed from a low potential to a high potential.

Preferably, in the first dead time, the interval decreasing from the high potential to the low potential and the interval rising from the low potential to the high potential does not overlap; in the second dead time, the interval decreasing from the high potential to the low potential and the interval rising from the low potential to the high potential does not overlap.

Preferably, duty cycles of the first control signal and the second control signal are the same, and the phase-shift is 180 degrees; the third control signal is complementary to the second control signal, and the fourth control signal is complementary to the first control signal.

Preferably, the first upper driving signal and the second middle driving signal are generated by the first control signal, and the second upper driving signal and the first middle driving signal are generated by the second control signal.

Compared with the prior art, the application has the following beneficial effects:

(1) In the present application, by means of optimizing the layout structure and winding method of the power conversion device, the thickness and volume of the power conversion device are further reduced.

(2) On the other hand, a control/driving mode of the power conversion apparatus is provided, and low-loss driving control of the plurality of switches is realized by means of four control signals.

### BRIEF DESCRIPTION OF THE DRAWINGS

FIG. 1A is a topology of a non-isolated power conversion circuit.

FIG. 1B is a topology of an isolated power conversion circuit.

FIG. 2A to FIG. 2C are driving circuits and timing diagrams.

FIG. 3A to FIG. 3C are schematic perspective structural diagrams.

FIG. 4A to FIG. 4E are schematic diagrams of winding.

### DESCRIPTION OF THE EMBODIMENTS

One of the cores of the present application is to provide a power conversion circuit. By optimizing the winding manner of the high-voltage winding and the low-voltage winding and the layout of corresponding components, the output capability of the power conversion device is improved, and the loss on the energy transmission path is reduced.

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

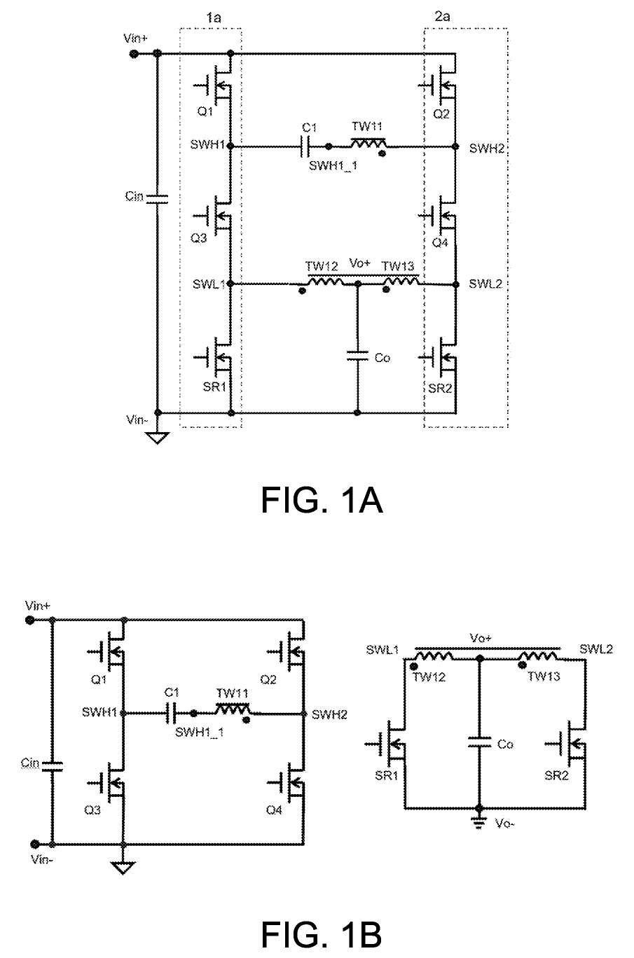

The proportional converter circuit disclosed in the present application is shown in FIG. 1A and FIG. 1B. FIG. 1A is a non-isolated power conversion circuit topology, and FIG. 1B is an isolated power conversion circuit topology. As shown in FIG. 1A, the non-isolated power conversion circuit comprises an input end, an output end, a first sub-circuit 1a, a second sub-circuit 2a, a magnetic assembly and a resonant capacitor; the input terminal comprises an input positive terminal Vin+ and an input negative terminal Vin-; and the output terminal comprises an output positive terminal Vo+ and an output negative terminal Vo-. In the present embodiment, the input negative terminal Vin- and the output negative terminal Vo- are shorted. Each sub-circuit includes an upper switch, a middle switch, and a lower switch that are sequentially connected in series. For example, the first sub-circuit 1a comprises an upper switch Q1, a middle switch Q3, and a lower switch SR1 connected in series in sequence; the second sub-circuit 2a comprises an upper switch Q2, a middle switch Q4, and a lower switch SR2 connected in series in sequence, wherein the upper switch Q1 is connected between the input positive terminal Vin+ and a first upper node SWH1, the middle switch Q3 is connected between the first upper node SWH1 and a first lower node SWL1, and the lower switch SR1 is connected between the first lower node SWL1 and the input negative terminal Vin-. The upper switch Q2 is connected between the input positive terminal Vin+ and a second upper node SWH2, the middle switch Q4 is connected between the second upper node SWH2 and a second lower node SWL2, and the lower switch SR2 is connected between the second lower node SWL2 and the input negative terminal Vin-. The magnetic assembly comprises a high-voltage winding TW11, a first low-voltage winding TW12 and a second low-voltage winding TW13, wherein the high-voltage winding TW11 and a resonant capacitor C1 are electrically connected in series to a connection point SWH1-1, and the high-voltage winding TW11 and the resonant capacitor C1 are connected in series to form a series branch, and the series branch is connected between the first upper node SWH1 and the second upper node SWH2. A second end of the first low-voltage winding TW12 and a second end of the second low-voltage winding TW13 are electrically connected to the output positive terminal Vo+; a first end of the first low-voltage winding TW12 is electrically connected to the first lower node SWL1, a first end of the second low-voltage winding TW13 is electrically connected to the second lower node SWL2. The proportional conversion circuit further comprises an input capacitor Cin and an output capacitor Co; the input capacitor Cin is connected between the input positive terminal Vin+ and the input negative terminal Vin-, and the output capacitor Co is connected between the output positive terminal Vo+ and the output negative terminal Vo-. A second end (equivalent to the upper node SWH2) of the high-voltage winding TW11, a first end (equivalent to the lower node SWL1) of the first low-voltage winding TW12 and a second end (equivalent to the output positive terminal Vo+) of the second low-voltage winding TW13 are dotted terminals, and are labeled as point ends.

The isolated power conversion circuit shown in FIG. 1B differs from that shown in FIG. 1A in that the input negative terminal Vin- and the output negative terminal Vo- are not shorted. The isolated power conversion circuit also comprises a first sub-circuit and a second sub-circuit, each sub-circuit comprising an upper switch and a middle switch electrically connected in series, and a lower switch. In the first sub-circuit, the upper switch Q1 is connected between the first upper node SWH1 and the input positive terminal Vin+, the middle switch Q3 is connected between the first upper node SWH1 and the input negative terminal Vin-, and the lower switch SR1 is connected between the first lower node SWL1 and the output negative terminal Vo-. In the second sub-circuit, the upper switch Q2 is connected between the input positive terminal Vin+ and the second upper node SWH2, the middle switch Q4 is connected between the second upper node SWH2 and the input negative terminal Vin-, and the lower switch SR2 is connected between the second lower node SWL2 and the output negative terminal Vo-. The input capacitor Cin is connected between the input positive terminal Vin+ and the input negative terminal Vin-. The connection manner of other components is the same as that of FIG. 1A, and details are not described again.

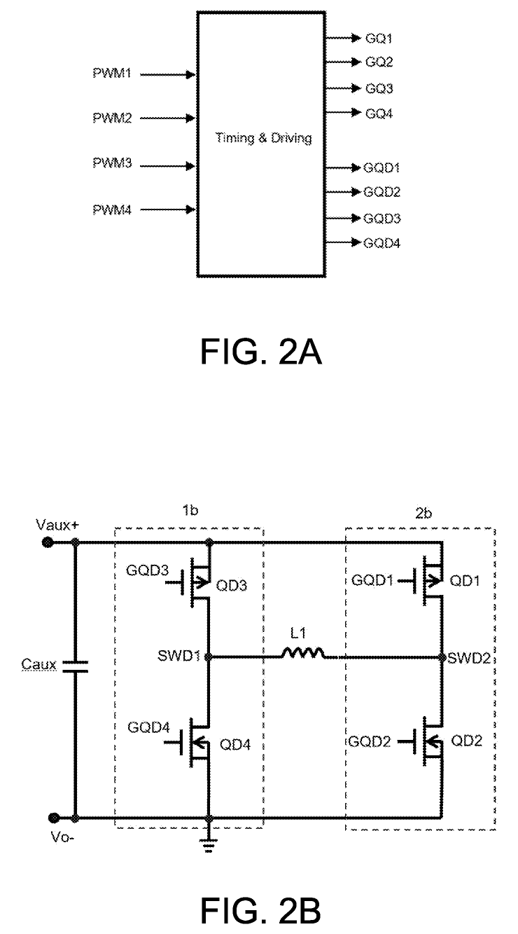

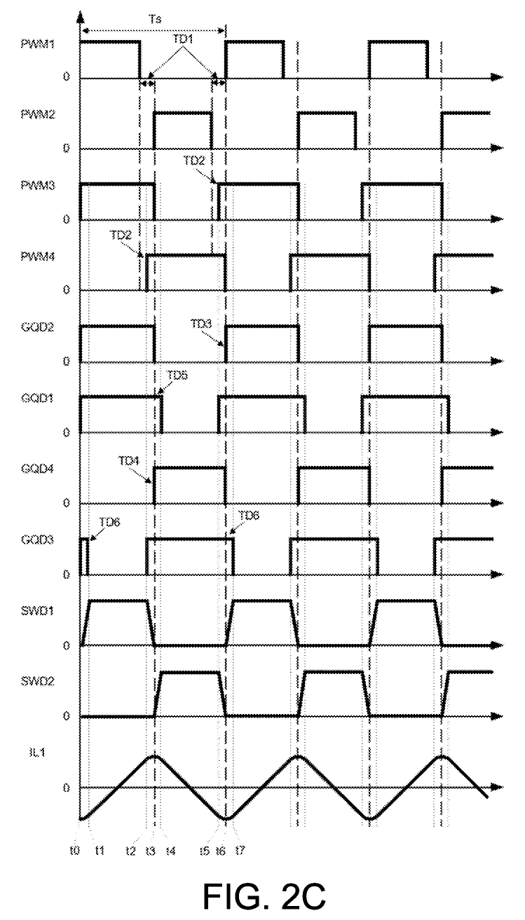

In order to reduce the driving loss, the present application further discloses a lossless driving circuit, which can be applied to the power conversion device of the circuit shown in FIG. 1A and FIG. 1B, and can be described in detail with reference to FIG. 2A to FIG. 2C. FIG. 2A shows a schematic diagram of a control signal, FIG. 2B shows a schematic diagram of a lossless driving circuit, and FIG. 2C shows a control signal and a driving signal timing. As shown in FIG. 2A, the lossless driving circuit comprises a first control signal PWM1, a second control signal PWM2, a third control signal PWM3, and a fourth control signal PWM4. Referring to FIG. 2C, the duty cycles of the first control signal PWM1 and the second control signal PWM2 are the same, the phase-shift of PWM1 and PWM2 is 180 degrees; a dead time TD1 exists between the first control signal PWM1 and the second control signal PWM2. The third control signal PWM3 is complementary to the second control signal PWM2; a dead time TD2 exists between the third control signal PWM3 and the second control signal PWM2. The fourth control signal PWM4 and the first control signal PWM1 are complementary; the dead time TD2 exists between the fourth control signal PWM4 and the first control signal PWM1.

The four control signals generate upper driving signals GQ1 and GQ2, middle driving signals GQ3 and GQ4, a first intermediate signal GQD1, a second intermediate signal GQD2, a third intermediate signal GQD3 and a fourth intermediate signal GQD4 by means of a timing control/driving circuit (Timing & Driving), wherein the upper driving signals GQ1 and GQ2 are respectively used for driving the turn-on and turn-off of the upper switches Q1 and Q2; the middle driving signals GQ3 and GQ4 are respectively used for driving the turn-on and turn-off of the middle switches Q3 and Q4. The upper driving signal GQ1 and the middle driving signal GQ4 are generated by the first control signal PWM1; the upper driving signal GQ2 and the middle driving signal GQ3 are generated by the second control signal PWM2. The presence of the dead time TD1 can avoid the pass-through of the upper switch and the middle switch.

As shown in FIG. 2B, the lossless driving circuit comprises an auxiliary positive terminal Vaux+, an auxiliary negative terminal (i.e., an output negative terminal Vo-), a driving inductor L1, an auxiliary capacitor Caux, a first driving bridge arm 1b and a second driving bridge arm 2b, wherein the first driving bridge arm 1b comprises an upper driving switch QD3 and a lower driving switch QD4 electrically connected in series; the second driving bridge arm 2b comprises an upper driving switch QD1 and a lower driving switch QD2 electrically connected in series, and both driving bridge arms 1b and 2b are connected between the auxiliary positive terminal Vaux+ and the output negative terminal Vo+. The upper driving switches QD1 and QD3 are PMOS, and the lower driving switches QD2 and QD4 are NMOS. The source electrodes of the upper driving switches QD1 and QD3 are both electrically connected to the auxiliary positive terminal Vaux+, and the sources of the lower driving switches QD2 and QD4 are both electrically connected to the output negative terminal Vo-. The drain of the upper driving switch QD3 and the drain of the lower driving switch QD4 are electrically connected to a first driving point SWD1, and the drain of the upper driving switch QD1 and the drain of the lower driving switch QD2 are electrically connected to a second driving point SWD2. A driving inductor L1 is electrically connected between the first driving point SWD1 and the second driving point SWD2. The auxiliary capacitor Caux is connected between the auxiliary positive terminal Vaux and the output negative terminal Vo-.

The first intermediate signal GQD1 and the second intermediate signal GQD2 are generated by the third control signal PWM3. By means of the timing control/driving circuit, the rising edge of the first intermediate signal GQD1 is consistent with the rising edge of the third control signal PWM3, and the falling edge of the first intermediate signal GQD1 lags behind that of the falling edge of the third control signal PWM3 by TD5, that is, the interval between time t3 and time t4. The rising edge of the second intermediate signal GQD2 lags behind the rising edge delay of the third control signal PWM3 by TD3, that is, the interval between time t5 and t6; and the falling edge of the second intermediate signal GQD2 is consistent with the falling edge of the third control signal PWM3.

The third intermediate signal GQD3 and the fourth intermediate signal GQD4 are generated by the fourth control signal PWM4. By means of the timing control/driving circuit, the rising edge of the third intermediate signal GQD3 is consistent with the rising edge of the fourth control signal PWM4; and the falling edge of the third intermediate signal GQD 3 lags behind the falling edge delay of the fourth control signal PWM4 by TD6, that is, the interval between time t6 and time t7; the rising edge of the fourth intermediate signal GQD4 lags behind the rising edge delay of the fourth control signal PWM4 by TD4, that is, the interval between the time t2 and the time t3; and the falling edge of the fourth intermediate signal GQD4 is consistent with the falling edge of the fourth control signal PWM4. Here, the delay TD3 is equal to the delay TD4, and the delay TD5 is equal to the delay TD6.

The first intermediate signal GQD1 is used for controlling the turn-on and turn-off of the upper drive switch QD1, and the second intermediate signal GQD2 is used for controlling the turn-on and turn-off of the lower drive switch QD2; the third control signal GQD3 is used for controlling the turn-on and turn-off of the upper drive switch QD3; and the fourth intermediate signal GQD4 is used for controlling the turn-on and turn-off of the lower drive switch QD4.

In the interval t0-t1, the second intermediate signal GQD2 is at a high level, and the lower driving switch QD2 is controlled to be turned on, so that the voltage of the second driving point SWD2 is at a low level (i.e., 0). In this case, because the first driving point SWD1 is electrically connected to the gate electrode of the lower switch SR1, the gate capacitor of the lower switch SR1 and the driving inductor L1 generate resonance, so that the voltage of the first driving point SWD1 changes from 0 to Vaux + (i.e., a high level). In the interval t1-t2, the third intermediate signal GQD3 is at a low level, and the upper drive switch QD3 is controlled to be turned on, so that the voltage of the first drive point SWD1 is Vaux+; the first drive point SWD1 is electrically connected to the gate electrode of the lower switch SR1, and therefore, the lower switch SR1 is turned on. In the interval t2-t3, the third intermediate signal GQD3 is at a high level, and the upper switch QD3 is turned off, so that the driving inductor L1 and the gate capacitor of the lower switch SR1 resonate, and the voltage of the first driving point SWD1 is changed from Vaux+ to 0, and the lower switch SR1 is turned off. In the interval t3-t4, the fourth intermediate signal GQD4 is at a high level, and the lower driving switch QD4 is turned on, so that the voltage of the first driving point SWD1 is 0, and the lower driving switch QD2 is in “off” state, the gate capacitor resonates with the driving inductor L1, and the voltage of the second driving point SWD2 is increased from 0 to Vaux+. In the interval t4-t5, the first intermediate signal GQD1 is at a low level, and the upper drive switch QD1 is turned on, so that the voltage of the second drive point SWD2 is Vaux+, and the lower switch SR2 is turned on. In the interval t5-t6, the first intermediate signal GQD1 is at a high level, and the upper driving switch QD1 is turned off, so that the driving inductor L1 and the gate capacitor of the lower switch SR2 resonate, and the voltage of the second driving point SWD2 is changed from Vaux+ to 0; and the interval between time t0 and time t6 is a complete switching period Ts.

The voltage waveforms of the first driving point SWD1 and the second driving point SWD2 are shown in FIG. 2C. When the delay TD3 is equal to the delay TD4, and the delay TD5 is equal to the delay TD6, the voltage waveform of the first driving point SWD1 is the same as the voltage waveform of the second driving point SWD2, and the phase-shift between the two voltage waveforms is 180 degrees. The first drive point SWD1 is electrically connected to the gate electrode of the lower switch SR1, and is used for controlling the turn-on and turn-off of the lower switch SR1; and the second drive point SWD2 is electrically connected to the gate electrode of the lower switch SR2, and is used for controlling the turn-on and turn-off of the lower switch SR2. The current waveform flowing through the driving inductor L1 is shown in FIG. 2C. By applying the driving circuit as shown in FIG. 2B, the driving loss of the lower switch can be further reduced, and the conversion efficiency of the power conversion device can be improved.

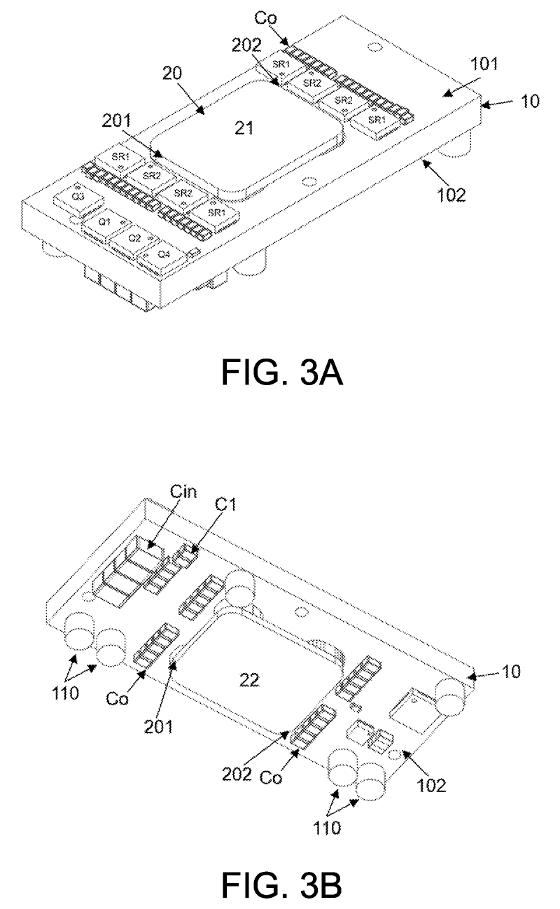

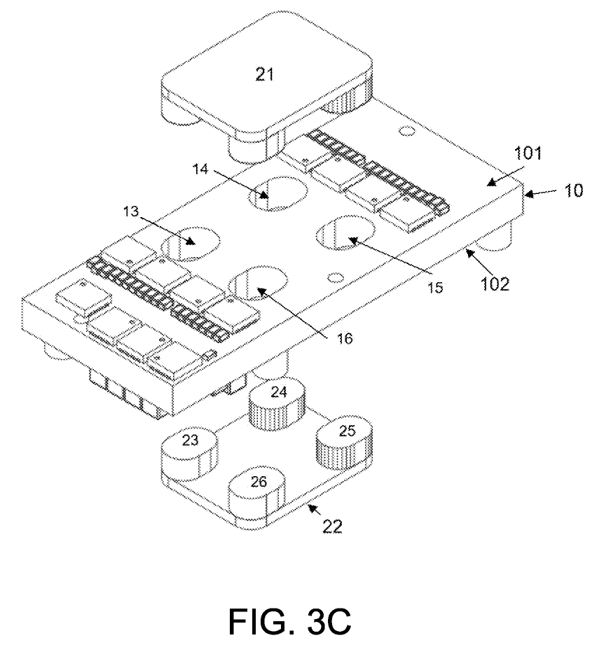

A layout of the power conversion device is also disclosed, with reference to FIGS. 3A to 3C, the power conversion device further comprises a substrate 10 and a magnetic core assembly 20, wherein the substrate 10 comprises an upper surface 101 and a lower surface 102 which are opposite to each other, and the magnetic core assembly 20 comprises an upper magnetic cover 21 and a lower magnetic cover 22; the four magnetic columns 23, 24, 25 and 26. The substrate 10 comprises four hole-grooves 13, 14, 15 and 16; each hole-groove is provided for a corresponding magnetic column to pass through; the upper magnetic cover 21 and the lower magnetic cover 22 are respectively assembled to the substrate from the upper surface 101 and the lower surface 102 of the substrate 10. The four hole-grooves 13, 14, 15 and 16 are arranged in a 2×2 array. A high-voltage winding and a low-voltage winding are arranged inside or on the surface of the substrate between adjacent-hole-grooves. The plurality of lower switches SR1 and SR2 are respectively arranged on two opposite sides of the magnetic core assembly 20. As shown in FIG. 3A, a group of lower switches is arranged along the first side 201 of the magnetic core assembly 20 according to the order of SR1-SR2-SR2-SR1, and the other group of lower switches is arranged along the second side 202 of the magnetic core assembly 20 in the order of SR1-SR2-SR2-SR1. In the present embodiment, the lower switch is disposed on the upper surface 101 of the substrate; in other embodiments, the lower switch may be disposed on the upper surface 101 and the lower surface 102 of the substrate, and adjacent to the side edges of the magnetic core assembly, and projections of the lower switches disposed on the upper surface and the lower surface on the same horizontal plane at least partially overlap. The upper switch Q1 and Q2, and the middle switch Q3 and Q4 are arranged adjacent to the group of lower switches, the drains of the upper switch Q1 and Q2 are electrically connected to the input positive terminal Vin+, the source of the upper switch Q1 is electrically connected to the drain of the middle switch Q3, the source of the upper switch Q2 is electrically connected to the drain of the middle switch Q4, the source of the middle switch Q3 is electrically connected to the drain of the lower switch SR1 and the first end of the low-voltage winding TW12, and the source of the middle switch Q4 and the drain of the lower switch SR2 and the first end of the low-voltage winding TW13 are electrically connected. In the present embodiment, the height difference between the upper surface of the switch and the upper surface of the magnetic assembly is less than 1 mm, thereby facilitating assembly of the heat dissipation assembly.

The power conversion device further comprises an output capacitor Co, an input capacitor Cin and an output electrical connector. In the present embodiment, the output capacitor Co is arranged on the upper surface 101 and the lower surface 102; on the upper surface 101, the output capacitor Co is arranged adjacent to each group of lower switches, that is, the lower switch is arranged between the output capacitor and the magnetic core; on the lower surface 102, the output capacitor Co is arranged on the first side 201 and the second side 202 of the magnetic core assembly, and the projections of the output capacitor Co on the lower surface 102 and the lower switch on the upper surface 101 on the same horizontal plane overlap by at least 30%. A source of the lower switch SR1 is short-circuited to a source of the SR2, a second end of the low-voltage winding TW12 is short-circuited with a second end of the TW13, and an output capacitor Co is connected between the source of the lower switch and the second end of the low-voltage winding. The resonant capacitor C1 is disposed on the lower surface 102 of the substrate and is disposed adjacent to the upper switch and the middle switch. The input capacitor Cin is disposed on the lower surface 102 of the substrate and is disposed adjacent to the upper switch and the middle switch; and the projections of the input capacitor Cin disposed on the lower surface 102 and the upper switch or the middle switch disposed on the upper surface 101 on the same horizontal plane overlap by at least 30%. The output electrical connector 110 is respectively disposed adjacent to the first side 201 and the second side 202 of the magnetic core assembly; the power conversion device further comprises an input electrical connector, the input electrical connector is disposed on the lower surface 102 of the substrate, the input electrical connector and the output electrical connector are used for being fixed and electrically connected to other components, and the other components may be an adapter board or a client system board.

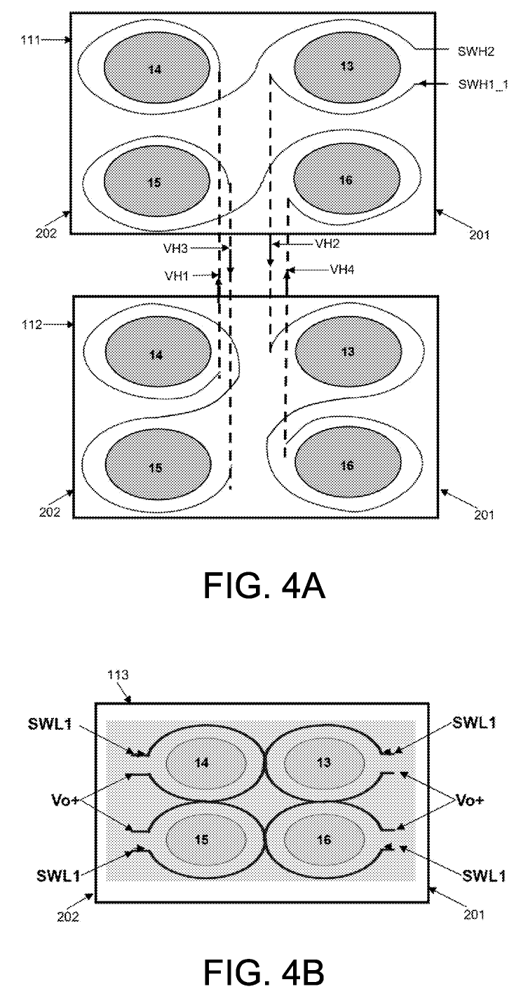

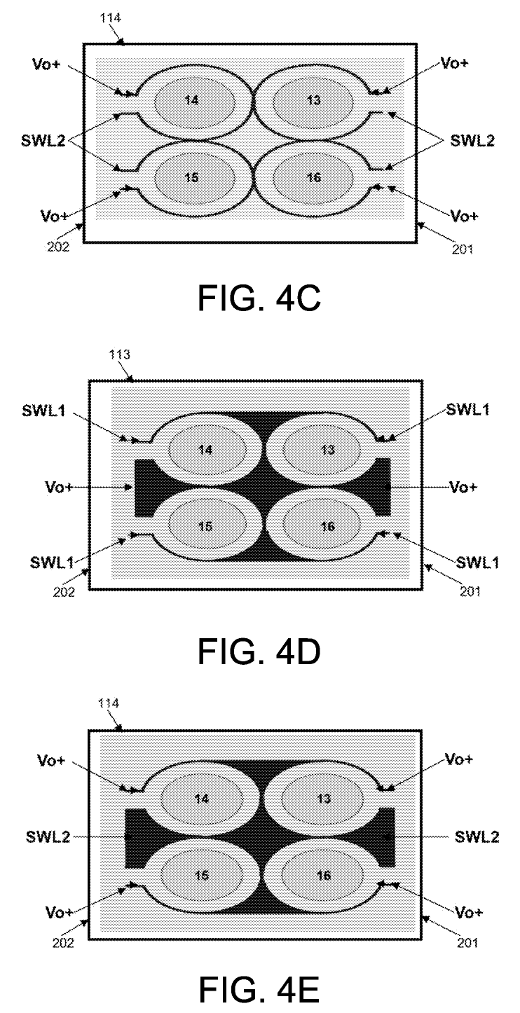

A winding manner of the high-voltage winding and the low voltage winding is also disclosed. As shown in FIG. 4A to FIG. 4E, the winding manner of the high voltage winding is shown in FIG. 4A, and starting from the node SWH1_1 (i.e., the short connection point of the resonant capacitor C1 and the high-voltage winding, that is, the first end of the high-voltage winding); first, half circle is wound clockwise around the first hole-groove 13 in the first layer 111; then, reached the second layer 112 by means of the second via hole VH2. Second, one circle is wound clockwise around the first hole-groove 13; then, one circle is wound counterclockwise around the fourth hole-groove 16; then, reached the first layer 111 by means of the fourth via hole VH4. Third, one circle is wound counterclockwise around the fourth hole-groove 16; and then, one circle is wound around the third hole-groove 15; then, reached the second layer 112 by means of the third via hole VH3. Fourth, one circle is wound clockwise around the third hole-groove 15; then, one circle is wound counterclockwise around the second hole-groove 14; then, reached the first layer 111 by means of the first via hole VH1. Finally, one circle is wound counterclockwise the second hole-groove 14; then half circle is wound around the first hole-groove 13 in a clockwise direction around the first hole-groove 13 to the SWH2 (i.e., the second end of the high-voltage winding).

One winding manner of the low-voltage windings TW12 and TW13 is shown in FIGS. 4B and 4C, a first end and a second end of the low-voltage winding TW12 are both arranged on the first side 201 and the second side 202 of the magnetic core assembly. In detail, the low-voltage winding TW12 is arranged in the third layer 113 and comprises four sub-windings, each sub-winding is wound around one hole-groove, and the winding directions on any two adjacent hole-grooves are opposite; for example, the low-voltage winding is wound one circle counterclockwise around the first hole-groove 13 from the first end (SWL1) to the second end (Vo +); one circle is wound clockwise around the second hole-groove 14 from the first end (SWL1) to the second end (Vo+); one circle is wound counterclockwise around the third hole-groove 15 from the first end (SWL1) to the second end (Vo+); and one circle is wound clockwise around the fourth hole-groove 16 from the first end (SWL1) to the second end (Vo+). At the first side 201 and the second side 202 of the magnetic core assembly, the second end of the low-voltage winding TW12 is disposed between the two first ends. The low-voltage winding TW 13 is provided on the fourth layer 114, and comprises four sub-windings. Each sub-winding is wound around one hole-groove, and the winding directions on any two adjacent hole-grooves are opposite. Moreover, on the first side 201 and the second side 202 of the magnetic core assembly, the first end (SWL2) of the low-voltage winding TW 13 is provided between the two second ends (Vo +). In the present embodiment, each low-voltage winding may also be implemented by using multiple layers in parallel. The first layer, the second layer, the third layer, and the fourth layer herein represent only different layers, and do not represent the arrangement order of each layer. The winding arrangement reduces the number of connected via holes and reduces the impedance of the winding. The winding directions of adjacent low-voltage windings are opposite, meaning that magnetic flux of adjacent magnetic columns is also reversed, which is beneficial to reduce the thickness of the upper cover and the lower cover of the magnetic core, and reduce thermal resistance.

In another embodiment, wiring adjacent to the low-voltage winding may also be short-circuited, or may be implemented by using a whole piece of copper. As shown in FIG. 4D and FIG. 4E, the wiring between any two adjacent hole-grooves is short. The parasitic parameters on the winding or between the windings can be further reduced, thereby improving the performance of the power conversion device.

The switch disclosed by the application can be used for realizing the functions of the switch disclosed by the application, such as a Si MOSFET，SiC MOSFET，GaN MOSFET or IGBT MOSFET.

The power supply module device according to the embodiment can be an independent module or a part of the electronic device, and can meet the technical features and advantages disclosed by the application.

The " equal " or " same " or " equal to " disclosed by the application needs to consider the parameter distribution of engineering, and the error distribution is within +/-30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/-30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A power conversion device, comprising:
a substrate, a magnetic core assembly, a winding, a first sub-circuit, and a second sub-circuit, wherein the first sub-circuit comprises four first lower switches, and the second sub-circuit comprises four second lower switches;
the magnetic core assembly comprises an upper magnetic cover, a lower magnetic cover, and four magnetic columns, the four magnetic columns are arranged between the upper magnetic cover and the lower magnetic cover, and the four magnetic columns are arranged in a manner of 2×2;
the substrate comprises an upper surface and a lower surface opposite to each other, and four hole-grooves, the hole-grooves passing through the upper surface and the lower surface, and each of the hole-grooves allowing one of the four magnetic columns to pass through; the upper magnetic cover and the lower magnetic cover respectively assembled the substrate from the upper surface and the lower surface; a winding is provided between the four hole-grooves;
the magnetic core assembly further comprises a first side and a second side opposite to each other; a lower switch set is provided along both the first side and the second side, and the lower switch set comprises a first lower switch, a second lower switch, a second lower switch, and a first lower switch arranged in sequence; a first end and a second end of the winding are arranged adjacent to the first side and/or the second side.

2. The power conversion device of claim 1, wherein the first sub-circuit further comprises a first upper switch and a first middle switch; the second sub-circuit further comprises a second upper switch and a second middle switch;
the power conversion device further comprises an input positive terminal, an input negative terminal, an output positive terminal and an output negative terminal;
a drain electrode of each of the upper switches is electrically connected to the input positive terminal, a source electrode of the first upper switch and a drain electrode of the first intermediate switch are connected to a first upper node, and a source electrode of the second upper switch and a drain electrode of the second middle switch are electrically connected to a second upper node;
the first lower switch is connected between a first lower node and the output negative terminal, and the second lower switch is connected between a second lower node and the output negative terminal; the first upper switch, the second upper switch, the first middle switch, and the second middle switch are all disposed on the first side of the magnetic core assembly and are all disposed adjacent to the lower switch set; a source of the first middle switch is electrically connected to the first lower node or the input negative terminal, and a source of the second middle switch is electrically connected to the second lower node or the input negative terminal.

3. The power conversion device of claim 1, further comprising an output capacitor, wherein the output capacitor is respectively disposed on the first side and the second side of the magnetic core assembly, and the output capacitor is disposed adjacent to the lower switch group; and the output capacitor disposed on the lower surface at least partially overlaps with a projection of the lower switch set disposed on the upper surface on the same horizontal plane.

4. The power conversion device of claim 2, further comprising an input capacitor, wherein the input capacitor is arranged on the lower surface of the substrate, the first upper switch, the second upper switch, the first middle switch and the second middle switch are arranged on the upper surface of the substrate, and projections of the input capacitor and at least one switch of the first upper switch, the second upper switch, the first middle switch and the second middle switch on the same horizontal plane at least partially overlap.

5. The power conversion device of claim 2, wherein the winding comprises a high-voltage winding, a first low-voltage winding, and a second low-voltage winding;
the power conversion device further comprises a resonant capacitor, wherein the resonant capacitor and the high-voltage winding are connected in series and then connected between the first upper node and the second upper node; a first end of the first low-voltage winding and a first end of the second low-voltage winding are electrically connected to a first lower node and a second lower node, respectively; a second end of the first low-voltage winding and a second end of the second low-voltage winding are connected with the output positive terminal.

6. The power conversion device of claim 5, wherein the resonant capacitor is disposed on the lower surface of the substrate, and the resonant capacitor is disposed adjacent to the first upper switch and the second upper switch.

7. The power conversion device of claim 1, further comprising two sets of output electrical connectors, wherein each set of the output electrical connectors is disposed on the first side and the second side of the magnetic core assembly, respectively.

8. The power conversion device of claim 5, wherein the four hole-grooves comprise a first hole-groove, a second hole-groove, a third hole-groove, and a fourth hole-groove; wherein the first hole-groove, the second hole-groove, the third hole-groove, and the fourth hole-groove are sequentially arranged in the same direction;
a first end and a second end of the high-voltage winding are both disposed adjacent to the first side of the magnetic core assembly, and the substrate is a multi-layer printed circuit board; from the first end to the second end of the high-voltage winding, first, wound half circle around the first hole-groove in a clockwise direction in a first layer, then, reached a second layer by means of a second via hole; second, wound one circle around the first hole-groove in clockwise direction, then wound one circle around the fourth hole-groove in counterclockwise direction, then reached the first layer by means of a fourth via hole; third, wound one circle around the fourth hole-groove in clockwise direction, then wound one circle around the third hole-groove in clockwise direction, then reached the second layer by means of a third via hole; fourth, wound one circle around the third hole-groove in clockwise direction, then wound one circle around the second hole-groove in counterclockwise, then reached the first layer by means of a first via hole; finally, wound one circle around the second hole-groove in counterclockwise, then wound half circle around the second hole-groove in clockwise direction, and go back to the second end.

9. The power conversion device of claim 8, wherein each of the low-voltage windings comprises four sub-windings, and each of the sub-windings is wound around one hole-groove; each of the low-voltage windings has opposite winding directions on any two adjacent hole-grooves; at the first side and the second side of the magnetic core assembly, the second end of the first low-voltage winding is disposed between the two first ends, and the first end of the second low-voltage winding is disposed between the two second ends.

10. A power conversion device, comprising:
a first sub-circuit, a second sub-circuit, four control signals, a timing control/driving circuit, and a low-loss driving circuit;
the first sub-circuit comprises a first upper switch, a first middle switch, and a first lower switch, and the second sub-circuit comprises a second upper switch, a second middle switch and a second lower switch;
the four control signals generate two upper driving signals, two intermediate driving signals, a first intermediate signal, a second intermediate signal, a third intermediate signal, and a fourth intermediate signal by means of the timing control/drive circuit; the two upper driving signals are respectively used for controlling the turn-on and turn-off of the first upper switch and the second upper switch, and the two intermediate driving signals are respectively used for controlling the turn-on and turn-off of the first middle switch and the second middle switch;
the first intermediate signal, the second intermediate signal, the third intermediate signal, and the fourth intermediate signal generate two lower driving signals via the low-loss driving circuit, and the two lower driving signals are respectively used to control the turn-on and turn-off of the first lower switch and the second lower switch;
the four control signals are a first control signal, a second control signal, a third control signal, and a fourth control signal.

11. The power conversion device of claim 10, wherein the first intermediate signal and the second intermediate signal are generated by the third control signal, and the third intermediate signal and the fourth intermediate signal are generated by the fourth control signal.

12. The power conversion device of claim 11, wherein a rising edge of the first intermediate signal is consistent with a rising edge of the third control signal, and a falling edge of the first intermediate signal is delayed from a falling edge of the third control signal; the rising edge of the second intermediate signal is delayed from the rising edge of the third control signal, and the falling edge of the second intermediate signal is consistent with the falling edge of the third control signal; the rising edge of the third intermediate signal is consistent with the rising edge of the fourth control signal, and the falling edge of the third intermediate signal is delayed from the falling edge of the fourth control signal; the rising edge of the fourth intermediate signal is delayed from the rising edge of the fourth control signal, and the falling edge of the fourth intermediate signal is consistent with the falling edge of the fourth control signal.

13. The power conversion device of claim 12, wherein the low-loss driving circuit comprises an auxiliary positive terminal, an auxiliary negative terminal, a driving inductor, a first driving bridge arm, and a second driving bridge arm;
the first driving bridge arm and the second driving bridge arm are both connected between the auxiliary positive terminal and the auxiliary negative terminal; the first driving bridge arm comprises a first upper driving switch and a first lower driving switch, and the first upper driving switch and the first lower driving switch are electrically connected in series to the second driving point; the second driving bridge arm comprises a second upper driving switch and a second lower driving switch, and the second upper driving switch and the second lower driving switch are electrically connected in series to the first driving point;
the driving inductor is connected between the first driving point and the second driving point; the auxiliary negative terminal is electrically connected to the output negative terminal;
the first intermediate signal is used for controlling the turn-on and turn-off of the first upper driving switch, the second intermediate signal is used for controlling the turn-on and turn-off of the first lower driving switch, the third intermediate signal is used for controlling the turn-on and turn-off of the second upper driving switch, and the fourth intermediate signal is used for controlling the turn-on and turn-off of the second lower driving switch.

14. The power conversion device of claim 13, wherein the first driving point is electrically connected to a gate electrode of the first lower switch and is used for driving the first lower switch to be turned on and turned off; the second driving point is electrically connected to a gate electrode of the second lower switch and is used for driving the turn-on and turn-off of the second lower switch;
a switching period of the power conversion device comprises a first interval, a second interval, a first dead time and a second dead time; in the first interval, the first driving point is at a high potential relative to the output negative terminal, and the second driving point is a low potential relative to the output negative terminal; in the second interval, the second driving point is at a high potential relative to the output negative terminal, and the first driving point is at a low potential relative to the output negative terminal; in the first dead time, a voltage of the first driving point relative to the output negative terminal is reduced from a high potential to a low potential, and a voltage of the second driving point relative to the output negative is changed from a low potential to a high potential; and in the second dead time, a voltage of the second driving point relative to the output negative terminal is reduced from a high potential to a low potential, and a voltage of the first driving point relative to the output negative terminal is changed from a low potential to a high potential.

15. The power conversion device of claim 14, wherein in the first dead time, the interval decreasing from the high potential to the low potential and the interval rising from the low potential to the high potential does not overlap; in the second dead time, the interval decreasing from the high potential to the low potential and the interval rising from the low potential to the high potential does not overlap.

16. The power conversion device of claim 10, wherein duty cycles of the first control signal and the second control signal are the same, and the phase-shift is 180 degrees; the third control signal is complementary to the second control signal, and the fourth control signal is complementary to the first control signal.

17. The power conversion device of claim 16, wherein the first upper driving signal and the second middle driving signal are generated by the first control signal, and the second upper driving signal and the first middle driving signal are generated by the second control signal.
